(19) United States
(12) Patent Application Publication
(10) Pub. No.: US 2007/0248228 A1
(43) Pub. Date: Oct. 25, 2007

(54) Audio and video recording apparatus

(75) Inventors: Hiromi Nishiura, Fujisawa (JP); Junji Shiokawa, Chigasaki (JP)

Correspondence Address: MCDERMOTT WILL & EMERY LLP, 600 13TH STREET, N.W., WASHINGTON, DC, 20005-3096, US

(73) Assignee: HITACHI, LTD.

(21) Appl. No.: 11/783,132

(22) Filed: Apr. 6, 2007

(30) Foreign Application Priority Data
Apr. 19, 2006 (JP) 2006-115149

(51) Int. Cl. H04N 7/167

(52) U.S. Cl. 380/239; 726/26

(57) ABSTRACT

Simultaneous recording of a digital content, which does not specify Copy Free, on recording medium of the same type is not authorized. Therefore, when a content that has been recorded by a recording/reproducing apparatus is being reproduced by the recording/reproducing apparatus, the content cannot be reproduced from the recording medium by any other reproducing apparatus. Moreover, when any other reproducing apparatus is used for reproduction, the content has to be moved from the recording/reproducing apparatus to the recording medium. This is inconvenient. In the recording/reproducing apparatus, data is recorded on one dismountable recording medium after it is encrypted using a local encryption key so that the data can be accessed by the recording/reproducing apparatus which has recorded the data. On the other recording medium, the data is recorded after it is encrypted without employment of the local encryption key so that the data can be accessed by any other reproducing apparatus.

### CLAIM OF PRIORITY

The present application claims priority from Japanese Application serial No. JP2006-115149, filed on Apr. 19, 2006, the content of which is hereby incorporated by reference into this application.

### BACKGROUND OF THE INVENTION

1. Field of the Invention

The present invention relates to a recording apparatus that records data, or more particularly, to limitations imposed on copy of data.

2. Description of the Related Art

Copyright protection technologies for protecting the copyright on video, music, or any other content are attracting attention. The copyright protection technologies include a Copy Once technology. Under implementation of the Copy Once technology, a recorded content can be backed up on a recording medium only once (in order to produce a child copy), but the child copy cannot be copied (in order to produce a grandchild copy).

For example, Japanese Unexamined Patent Publication No. 2005-317051 describes a technology in which a Copy Once content recorded in a first optical disk is deleted and moved to a second disk, that is, the Copy Once content can be recorded on the second optical disk without an opposition to the attributes of the Copy Once content.

Moreover, Japanese Unexamined Patent Publication No. 2006-041582 describes a technology in which: a specific ID is assigned to each recording/reproducing equipment; and as long as data is recorded after being encrypted for fear it may be reproduced by any equipment other than recording/reproducing equipment whose ID corresponds to the specific ID, multiple copies can be produced from even a content permitted to be copied only once.

Moreover, Japanese Unexamined Patent Publication No. 2005-354225 describes a technology in which when Copy Once restrictions are imposed on a content, the Copy Once content is inhibited from being recorded simultaneously onto two or more medium (irrespective of whether the contents are identical).

### SUMMARY OF THE INVENTION

According to the technology described in Japanese Unexamined Patent Publication No. 2005-317051, the content is deleted from the first optical disk.

According to the technology described in Japanese Unexamined Patent Publication No. 2006-041582, even when multiple copies are produced, they cannot be reproduced by equipment other than the recording/reproducing equipment that has recorded the content.

According to the technology described in Japanese Unexamined Patent Publication No. 2005-354225, even when a content is recorded by, for example, a home recorder, family members cannot enjoy the content independently of one another.

However, with the advent of a so-called ubiquitous society, any content has come to be able to be enjoyed in any place other than home. For outdoor enjoyment of a content, for example, a display included in a car navigation system or a display included in handheld equipment (such as, a portable cellular phone, a handheld game machine, or a portable music player) can be utilized. Assuming that one member of a family watches a program (content), which is recorded by a home recorder, at home, if any other member thereof can enjoy the program outdoors, the users would find it convenient because they can spend time effectively. However, such a merit is not provided by Japanese Unexamined Patent Publications Nos. 2005-317051, 2006-041582, and 2005-354225.

However, restrictions to be imposed in order to protect copyright should be observed as they are taken into consideration in Japanese Unexamined Patent Publications Nos. 2005-317051, 2006-041582, and 2005-354225. For example, after a Copy Once content that is broadcasted is recorded, copy thereof is not permitted. According to the standards for digital broadcasting, it is not authorized that one data stream of one digital signal having passed through a tuner is simultaneously recorded in multiple recording medium of the same type under the same security specification. The deed is regarded as duplication from the viewpoint of content protection.

Accordingly, there is provided a technology in which when one content is recorded in multiple recording medium of the same type, different restrictions are imposed on a first recording medium and a second recording medium. In particular, there is provided a recording apparatus in which restrictions are imposed so that data recorded on one of the recording medium can be reproduced by a recording/reproducing apparatus which has recorded the data but cannot be reproduced by any other reproducing apparatus.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an example of a configuration of a recording/reproducing apparatus;

FIG. 2 is a block diagram showing an example of a configuration of an encryption circuit;

FIG. 3 is a block diagram showing an example of a configuration of a decryption circuit;

FIG. 4 is a flowchart describing an example of encryption circuit path designation (in a case where an input signal does not specify Copy Free); and

FIG. 5 is a flowchart describing an example of encryption circuit path designation (in a case where an input signal specifies Copy Free).

### DESCRIPTION OF THE PREFERRED EMBODIMENTS

A preferred embodiment of the present invention will be described below. The present embodiment will be described on the assumption that a digital signal which has been digitally broadcasted is recorded or reproduced on or from an information versatile disk for removal usage (iVDR). However, the digital signal and medium are not limited to the digitally broadcasted signal and the iVDR.

To begin with, a copyright management technology for digital broadcasting, or especially, a copy control technology will be described below. For example, a digital signal sent from a broadcasting station contains copy control information. The copy control information to be contained in data that is digitally broadcasted falls into four kinds presented below. When a user uses his/her recording medium to produce a backup copy, restrictions are imposed based on the kind of copy control information.

Never Copy: signifies that copy is never permitted. Since copy is not permitted, a user cannot back up data.

Copy Once: signifies that copy is permitted only once. A user can back up data only once (so as to produce a child copy).

No More Copy: is copy control information to be contained in a child copy produced from Copy Once data. A user cannot produce a copy (a grandchild copy) from the child copy.

Copy Free: signifies that copy is permitted any number of times. A user can copy data any number of times.

Next, the iVDR will be described below.

The performances of various pieces of equipment including personal computers, audiovisual (AV) equipment, home information appliances, and onboard information equipment have improved, and an amount of information to be transacted among pieces of equipment has increased. An optical disk that utilizes a laser is adopted as a recording medium usable in common among these pieces of equipment. The employment of a recorder, which is designed to record data on a hard disk and has been adopted mainly for personal computers, in AV equipment is widely accepted. Standardization is under way in efforts to adopt a removable cartridge in addition to a built-in hard disk so that the removable cartridge can be shared by the various pieces of equipment via a common interface. What is taken as an example of the removable cartridge is the iVDR. Along with the recent evolution of digital storage medium, techniques for compressing and recording a long-running motion picture and sounds in a storage medium have been discussed. A long-running motion picture such as a movie can now be recorded in one medium with high image quality ensured. By the way, hard disk drives (HDDs) that are generally adopted as a main storage device to be included in a personal computer or the like are having a larger storage capacity and becoming lower-cost. Recorders having a built-in AV HDD are gaining popularity. Eventually, the iVDR has been developed by overcoming one of the drawbacks of the HDD that is poor performance in withstanding an impact and by improving data security performance that has been controversial in recent years. The features of the iVDR are, for example, as described below.

1. The iVDR is a removable hard disk drive that is compact, lightweight, and portable.

2. Although the iVDR is removable, since it is a hard disk drive, it permits recording supported by a large storage capacity and high-speed random access.

3. An interface (signaling unit) included in the iVDR conforms to the serial advanced technology attachment (ATA) specification and supports fast data transfer to be performed at a rate of 1.5 Gbps.

4. The employment of multiple iVDRs allows a user to readily construct a server having a storage capacity of tera-bytes.

5. For the iVDR, a security specification has been formulated based on a public key infrastructure (PKI). Thus, protection of recorded data/information or protection of a copyrighted digital content is realized. For example, the security architecture for intelligent attachment device (SAFIA) is a kind of security specification.

Owing especially to the feature of item 5, the iVDR is expected to further prevail as a recording medium that has an ability to cope with copyright management on which greater emphasis will be put along with digitization of various kinds of data items.

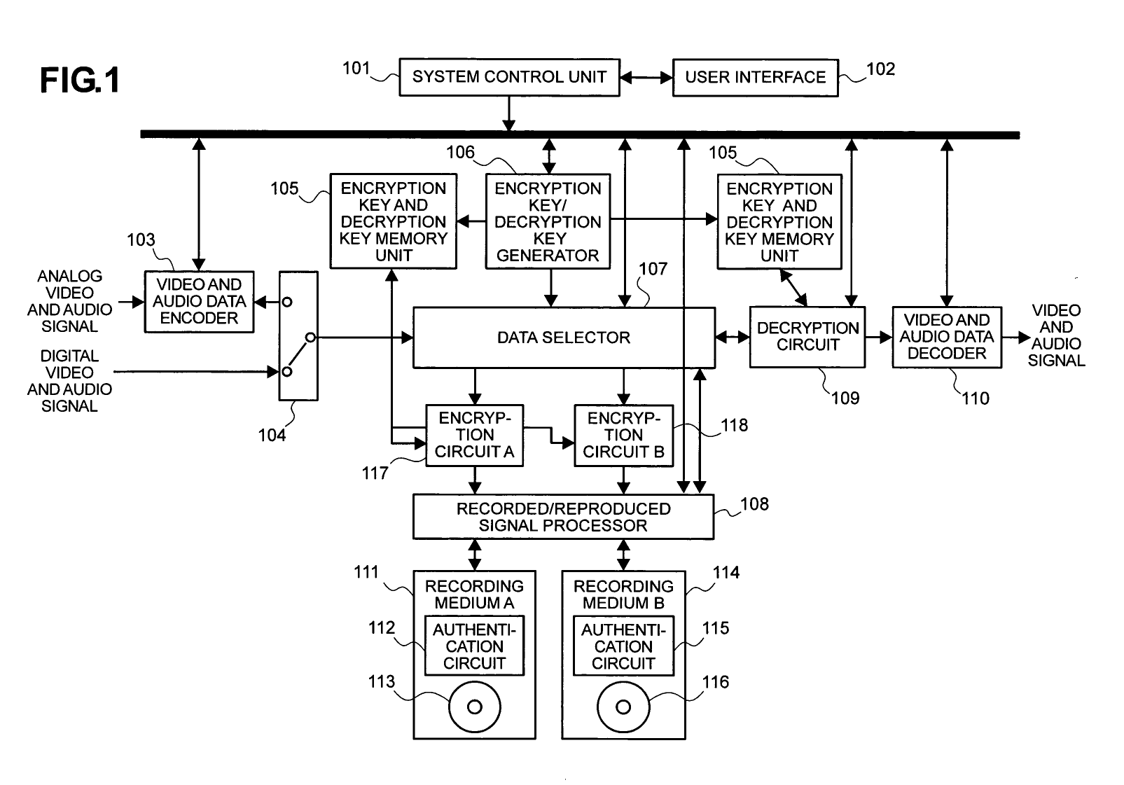

FIG. 1 is a block diagram showing an example of a configuration of a recording/reproducing apparatus. The recording/reproducing apparatus can receive digitally broadcasted data and record the data on a recording medium, or can reproduce recorded data and provide a reproduced output.

A recording medium A 111 includes an authentication circuit 112 and a data recording area 113. A recording medium B 114 also includes an authentication circuit 115 and a data recording area 116. In the present embodiment, the recording medium A and B are, as mentioned above, iVDRs. However, aside from the iVDR, any recording medium can be adopted as long as the recording medium has a security specification defined therefor and can protect copyrighted digital contents against recording or reading. Moreover, the recording medium A and B are of the same type. Herein, what are referred to as the recording medium of the same type are identical iVDRs. The recording medium are of the type different from HDDs (3.5 or 2.5 inch in diameter) other than the iVDR, or of the type different from HDDs, DVDs, and semiconductor memories. In other words, assuming that data is concurrently recorded on recording medium, if the deed is regarded as violation of the copyright law (duplication) from the viewpoint of copyright management, the recording medium are called medium of the same type.

The components shown in FIG. 1 will be described below, and their actions will be outlined in due course.

To begin with, actions to be performed in a case where information encrypted conformably to a security specification for a recording medium is recorded or reproduced on or from the recording medium B114 will be described below. What is referred to as encryption conformable to a security specification for a recording medium is encryption to be performed according to a method stipulated in a specification for a recording medium concerned. Data encrypted conformably to the security specification and recorded on the recording medium is decrypted conformably to the security specification and reproduced by an authentic recording/reproducing apparatus conformable to the specification.

Reference numeral 101 denotes a system control unit that controls the components shown in FIG. 1. Reference numeral 102 denotes a user interface that receives information which a user has keyed in. Reference numeral 103 denotes an encoder that performs MPEG-conformable encoding in a case where a received video and audio signal is an analog signal. Reference numeral 104 denotes a switching circuit that switches a signal sent from the encoder 103 and a digital video signal (hereinafter, generically, a video signal) which is an MPEG-conformable data stream which has bypassed the encoder 103 and has been encoded conformably to the MPEG standard, and that thus determines whichever of the signal received from the encoder and the digital video signal should be received.

Reference numeral 107 denotes a data selector whose action will be described later. Herein, data shall be sent from the data selector 107 to an encryption circuit B 118. The system control unit 101 included in the recording/reproducing apparatus and the authentication circuit 115 cooperate with each other in authenticating data. If authenticity is established, the system control unit 101 designates encryption conformable to the security specification for the recording medium, and the encryption circuit B 118 encrypts the data. The resultant data is recorded in the data recording area 115 in the storage medium B 114.

For reproduction of data from the recording medium B 114, after the authenticity of the recording medium is established, a recorded/reproduced signal processor 108 transfers the data, which is read from the recording medium B 114, to a decryption circuit 109 via the data selector 107. The system control unit 101 designates decryption conformable to the security specification for the recording medium. The decryption circuit 109 decrypts the data. A video and audio data decoder 110 performs MPEG-conformable decoding. The resultant data is transmitted as a video and audio signal.

Next, a description will be made of actions to be performed in a case where local encryption different from the encryption conformable to a security specification for a recording medium is performed in order to record or reproduce data on or from the recording medium A 111. What is referred to as local encryption is encryption or decryption to be performed using an encryption key or a decryption key produced based on information specific to a recording/reproducing apparatus or pieces of information (IDs or the like) specific to the recording/reproducing apparatus and a recording medium respectively. The encryption key and decryption key generated by a local encryption key/local decryption key generator 106 are fixed encryption key and decryption key that are determined uniquely for a recording medium by the recording/reproducing apparatus. In this case, an encryption key to be used in common among contents to be recorded in a recording medium may be used for encryption, or an encryption key and a decryption key generated for each recorded content by the encryption key/decryption key generator 106 may be adopted. Data subjected to local encryption and recorded in a recording medium by the recording/reproducing apparatus of the present embodiment is allowed to be reproduced only when the recording/reproducing apparatus and recording medium are used in combination. The data subjected to local encryption and recorded in the recording medium by any other recording/reproducing apparatus cannot be reproduced by the recording/reproducing apparatus of the present embodiment.

A video signal is transmitted to the encryption circuit A 117 via the switching circuit 104 and data selector 107. The system control unit 101 instructs the encryption key/decryption key generator to generate a local encryption key and a decryption key that is used to decrypt encrypted data, and holds the keys in an encryption key and decryption key memory unit 105. The encryption circuit A 117 uses the encryption key to perform local encryption. If the system control unit 101 and the authentication circuit 112 included in the recording medium A 111 establish authenticity, the recorded/reproduced signal processor 108 records an encrypted signal in the recording area 113.

For reproduction of data from the recording medium A 111, if the system control unit 101 and authentication circuit 112 establish authenticity in the same manner as they do for recording, the recorded/reproduced signal processor 108 transfers data read from the recording area 113 to the decryption circuit 109 via the data selector 107. The decryption circuit 109 uses the decryption key stored in the decryption key memory unit 105 to decrypt data having undergone local encryption. The video and audio data decoder 110 performs MPEG-conformable decoding. The resultant data is transmitted as a video and audio signal.

Recording or reproduction of a signal on or from the recording medium A or B has been described so far. Next, a description will be made of actions to be performed in a case where a video signal containing Copy Enabled/Disabled control information is simultaneously and concurrently (in parallel) recorded or reproduced on or from the recording medium A and B. Herein, when it says that a video signal is concurrently (in parallel) recorded or reproduced, it means not only that pieces of processing are concurrently (in parallel) performed but also that the pieces of processing are performed in a time-sharing manner according to, for example, the multitasking method. Moreover, even when it says that a video signal is simultaneously recorded or reproduced, the pieces of processing may not be performed simultaneously.

Data subjected to MPEG-conformable encoding and sent from the switching circuit 104 is transferred to the data selector 107. The encryption circuit A 117 performs local encryption. At this time, the system control unit 101 instructs the encryption key/decryption key generator 106 to designate a local encryption key and a decryption key to be used to decrypt encrypted data, and holds the keys in the encryption key and decryption key memory unit 105. The encryption circuit A 117 uses the designated encryption key to perform local encryption. If the system control unit 101 and the authentication circuit 112 included in the recording medium A 111 establish authenticity, the encrypted signal is recorded in the recording area 113 by the recorded/reproduced signal processor 108. Moreover, the data subjected to MPEG-conformable encoding is also transferred from the data selector 107 to the encryption circuit B 118. The encryption circuit B 118 does not perform local encryption but encrypts the data conformably to the security specification for the recording medium. At this time, the system control unit 101 instructs the encryption key/decryption key generator 106 to designate a security-specification encryption key and a decryption key to be used to decrypt encrypted data, and holds the keys in the encryption key and decryption key memory unit 105. The encryption circuit B 118 uses the designated encryption key to encrypt the data conformably to the security specification. If the system control unit 101 and the authentication circuit 115 included in the recording medium A 114 establish authenticity, the encrypted signal is recorded in the recording area 116 by the recorded/reproduced signal processor 108.

Incidentally, when a received video signal does not contain control information on whether copy is enabled or disabled but specifies Copy Free, the system control unit 101 does not instruct the encryption circuit to perform local encryption. Data sent from the switching circuit 104 is transferred to the data selector 107. The encryption circuits A 117 and B 118 do not perform local encryption. The recorded/reproduced signal processor 108 records the data in the recording medium A 111 and B 114. When data items are reproduced from the recording medium A 111 and B 114 respectively, they are transmitted to the decryption circuit 109 via the recorded/reproduced signal processor 108. However, the system control unit 101 does not instruct the decryption circuit 109 to perform decryption. The video and audio data decoder 110 performs MPEG-conformable decoding. The resultant data is transmitted as a video and audio signal.

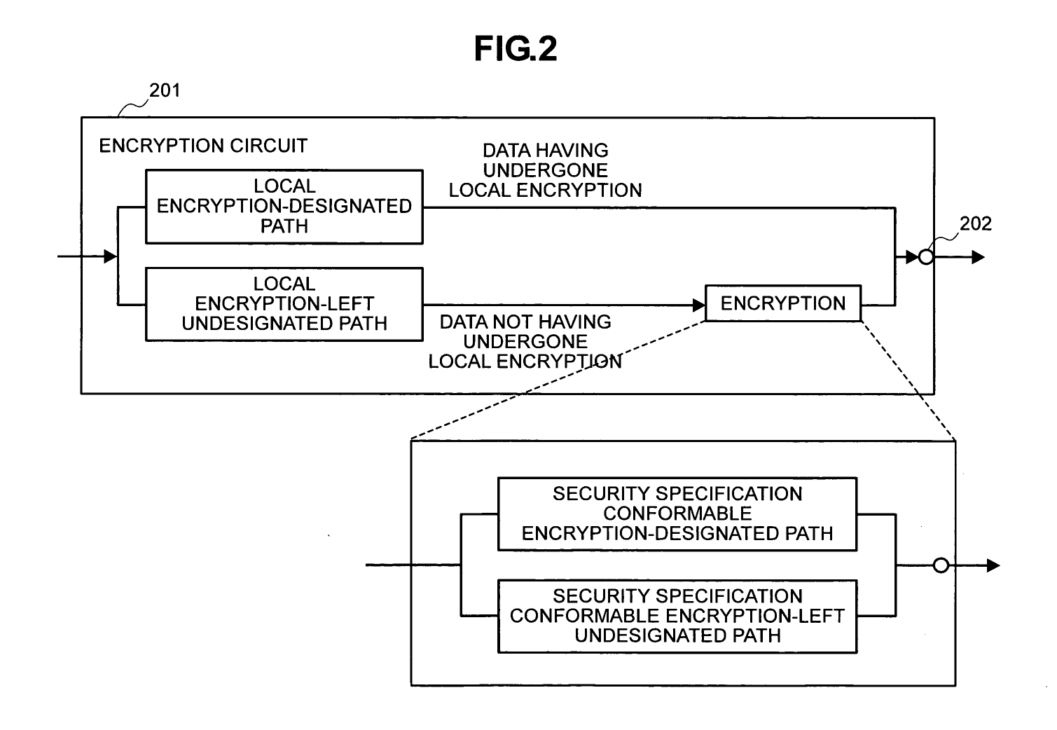

Next, the foregoing actions will be detailed with reference to FIG. 2 to FIG. 5.

FIG. 2 is a block diagram showing an example of a configuration shared by the encryption circuits A 117 and B 118. When local encryption is performed on a content containing control information on whether copy is enabled or disabled, a signal is routed to a local encryption-designated path, and transmitted through an output port A 202 of the encryption circuit. When local encryption is not performed on the content, the signal is routed to a local encryption-left undesignated path, encrypted conformably to the security specification, and transmitted through the output port A 202 of the encryption circuit. A content devoid of control information on whether copy is enabled or disabled is routed to the local encryption-left undesignated path. Moreover, encryption conformable to the security specification is also left undesignated, and the encryption is not performed. The signal is transmitted through the output port A 202 of the encryption circuit. Switching of the paths is controlled by the system control unit 101.

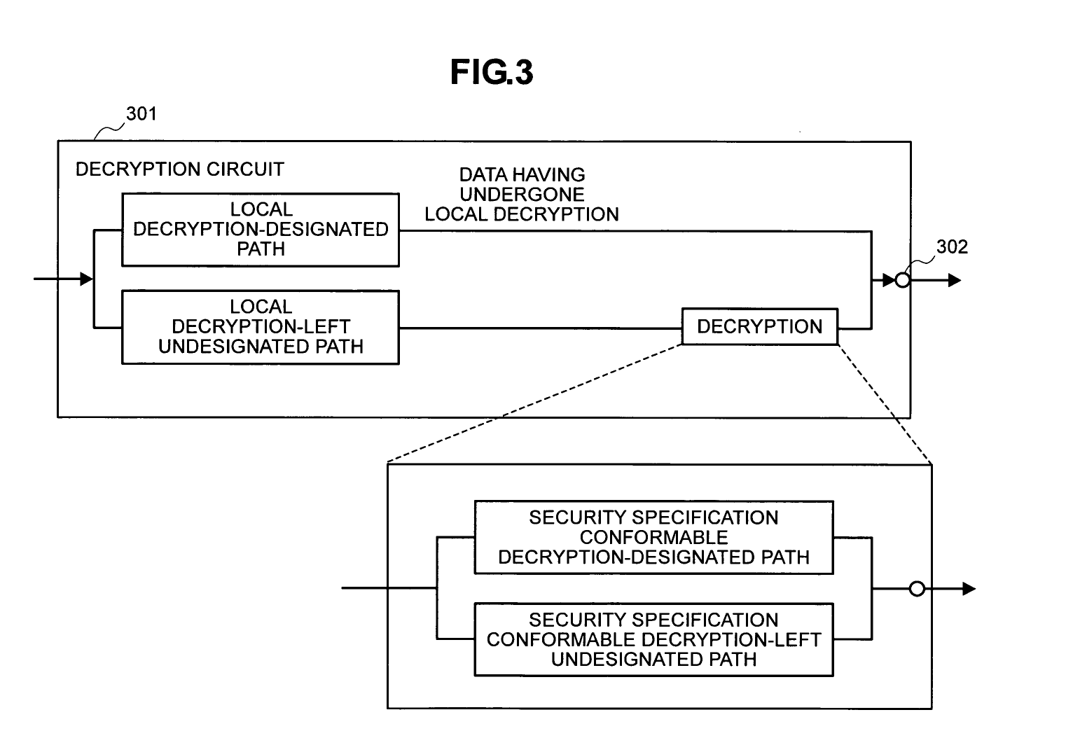

FIG. 3 is a block diagram showing an example of the configuration of the decryption circuit 109. For decryption of data recorded in the recording area, if the data has undergone local encryption, the data is routed to a local decryption-designated path, then decrypted, and transmitted through an output port A 302 of the decryption circuit. If a signal has not undergone local encryption but has been encrypted conformably to the security specification, the signal is routed to a local decryption-left undesignated path but is not subjected to local decryption. The signal is routed to a security specification conformable decryption-designated path, decrypted, and then transmitted through the output port A 302 of the decryption circuit. Moreover, if a signal has not undergone local encryption and has not been encrypted conformably to the security specification, the signal is routed to the local decryption-left undesignated path but is not subjected to local decryption. The signal is then routed to a security specification conformable decryption-left undesignated path, and transmitted through the output port A 302 of the decryption circuit without being decrypted. Switching of the paths is controlled by the system control unit 101. Alternatively, the switching may be autonomously performed based on information on encryption of a content.

Next, actions to be performed in a case where the same content is concurrently recorded in the recording medium A and B will be detailed below.

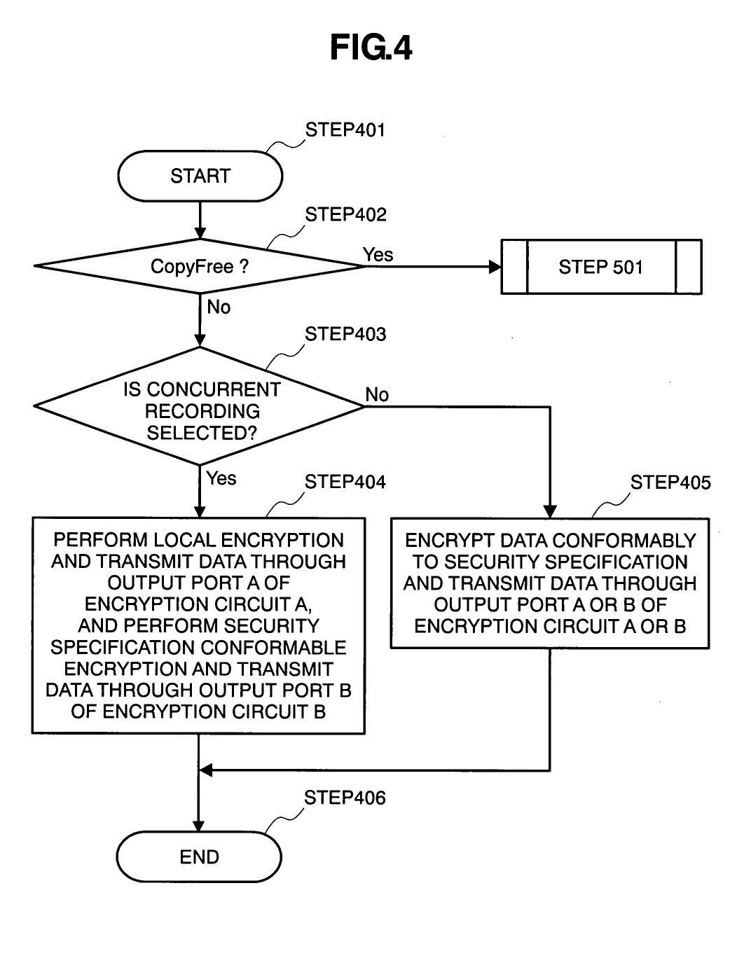

FIG. 4 describes a flow of encryption circuit path designation which the system control unit 101 executes according to the type of recording medium when an input signal does not specify Copy Free.

In response to an operational instruction of a recording request sent from the user interface 102 (step 401), the system control unit 101 decides whether an object-of-recording content specifies Copy Free (step 402). If the content does not specify Copy Free, the system control unit decides whether the content should be concurrently recorded in the recording medium A and B (step 403). Whether concurrent recording is selected may be decided based on the operational instruction entered at the user interface 102 or may be determined in advance. If concurrent recording is selected, the system control unit 101 routes the data to the encryption circuits A and B via the data selector 107, and controls designation or non-designation of encryption to be determined by the encryption circuits A and B. Moreover, the system control unit 101 instructs the encryption circuit A to perform local encryption on data, and instructs the encryption circuit B to encrypt the data conformably to the security specification for the recording medium (step 404). If concurrent recording is not selected, the system control unit 101 routes the data to the encryption circuit A or B via the data selector 107, and controls designation or non-designation of encryption to be determined by the encryption circuit A or B. The input signal is not subjected to local encryption but is encrypted conformably to the security specification for the recording medium and then transmitted (step 406).

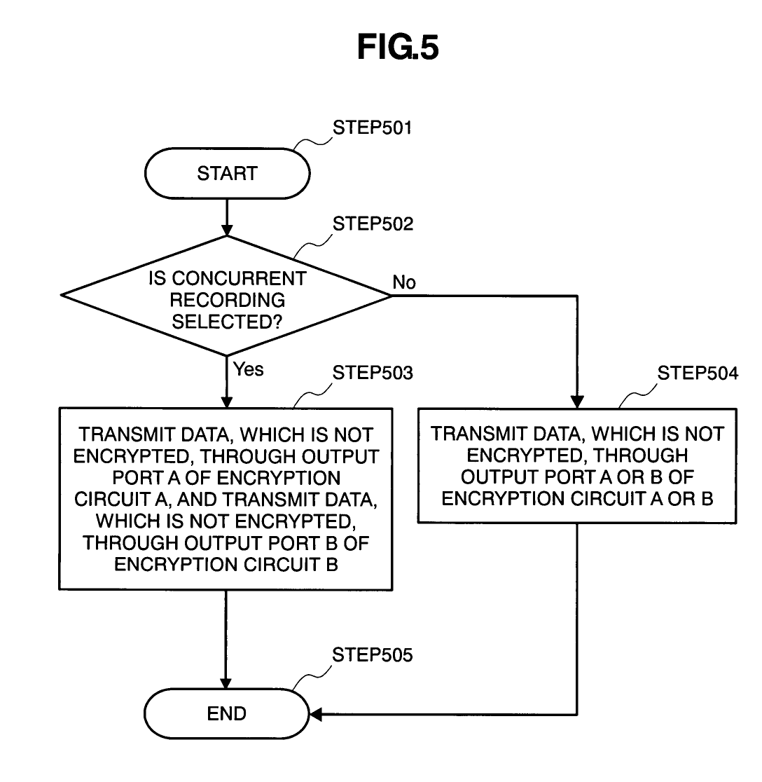

FIG. 5 describes a flow of encryption circuit path designation to be executed by the system control unit 101 when an input signal specifies Copy Free.

When an input signal specifies Copy Free (Yes at step 402), the system control unit 101 decides whether concurrent recording is selected (step 502). If concurrent recording is selected, the system control unit 101 routes the data to the encryption circuits A and B via the data selector 107, and controls designation or non-designation of encryption to be determined by the encryption circuits A and B. The system control unit 101 instructs the encryption circuits A and B to perform neither local encryption nor encryption conformable to the security specification of the recording medium on the input signal, and to transmit data that is not encrypted (step 503). If concurrent recording is not selected, the system control unit 101 controls designation or non-designation of encryption to be determined by the encryption circuit A or B. The input signal is not encrypted (step 504), but data is transmitted through the output port A or B of the encryption circuit (step 505).

The system for performing local encryption on data and recording or reproducing the data on or from the recording medium A, or for encrypting data conformably to the security specification for the recording medium B and recording or reproducing the data on or from the recording medium B has been described so far. Incidentally, if a content is recorded on one of the medium or different contents are recorded on the respective medium, the content may be encrypted conformably to the security specification for the recording medium A and recorded in the recording medium A, and the other content may be encrypted conformably to the security specification for the recording medium B and recorded in the recording medium B. If the same content is concurrently recorded in the recording medium A and B, the content may be subjected to local encryption and then recorded in the recording medium A, and may be encrypted conformably to the security specification for the recording medium B and recorded in the recording medium B. In this case, unless the same content is recorded simultaneously in the recording medium A and B, local encryption is not employed. Therefore, if a content is recorded in one of the recording medium or if different contents are recorded in the respective recording medium, the content is encrypted according to the security specification for the recording medium and then recorded therein. In this case, any other reproducing apparatus supporting the security specifications for the recording medium can reproduce the contents from the recording medium A and B respectively.

According to the present embodiment, although the recording medium A and B are of the same type, they can be treated as different types of recording medium from the viewpoint of content handling. Consequently, the same content can be recorded concurrently on the recording medium of the same type. Assuming that a content is recorded on, for example, the dismountable recording medium B, the recording medium may be dismounted from the recording/reproducing apparatus. While the content is reproduced from the recording medium B by any other reproducing apparatus, the same content can be reproduced from the recording medium A by the recording/reproducing apparatus. However, when the dismountable recording medium A is connected to any other reproducing apparatus, since the content is subjected to local encryption, the recording/reproducing apparatus cannot access and reproduce the content.

The recording medium A and B may be designed to be readily mountable or dismountable from the recording/reproducing apparatus. At least one of the recording medium may be incorporated in the recording/reproducing apparatus (is not supposed to be readily mounted or dismounted by a user). A certain content may be subjected to local encryption and then recorded in the recording medium A. Moreover, the content may be encrypted conformably to the security specification for the recording medium B and then recorded in the recording medium B. Another content may be encrypted conformably to the security specification for the recording medium A and then recorded therein. Moreover, the content may be subjected to local encryption and then recorded in the recording medium B. In this case, both the recording medium A and B should preferably be dismountable.

In the present embodiment, a digital content recorded in the recording medium A may be moved to the recording medium B. If a content that has not undergone local encryption is recorded in the recording medium A, the content can be moved to the recording medium B via the recorded/reproduced signal processor 108. When a content is subjected to local encryption and then recorded in the recording medium A, the recorded/reproduced signal processor 108 transmits the data read from the recording medium A to the decryption circuit 109 via the data selector 107. The decryption circuit 109 decrypts the data having undergone local encryption, and returns the data to the recorded/reproduced signal processor 108 via the data selector 107. Consequently, the data is recorded in the recording medium B.

The present embodiment has been described on the assumption that a security specification is defined for a recording medium (iVDR or the like). The present invention is not limited to the type of recording medium. Alternatively, medium for which the security specification is not defined will do. Moreover, the security specification may be defined not for the recording medium but for a content. Otherwise, the security specification may be defined for a copy source such as a digital broadcast signal.

Moreover, in the present embodiment, contents to be recorded in the recording medium A and B respectively are subjected to any kind of encryption. Some contents may be subjected to local encryption before being recorded in one of the recording medium, and may not be encrypted at all before being recorded in the other recording medium.

For a description of the present embodiment, encryption conformable to a security specification and local encryption have been taken for instance. Encryption is generally performed in order to guarantee the security of data. As long as security is guaranteed, encryption may not be performed. Encryption and a method including encryption may be generically referred to as restrictions for security, restrictions on reproduction, or restrictions. Otherwise, reproduction inhibition or reproduction suppression may be adopted in order to emphasize that reproduction is not allowed.

Thus, a recorded content can be enjoyed in multiple places.

While we have shown and described several embodiments in accordance with out invention, it should be understood that disclosed embodiments are susceptible to changes and modifications without departing from the scope of the invention. Therefore, we do not intend to be bound by the details shown and described herein but intend to cover all such changes and modifications as fall within the ambit of the appended claims.

What is claimed is:

1. A recording apparatus that records a digital signal on a recording medium, comprising:
a recording unit that records the digital signal on a first recording medium and a second recording medium of the same type as the first recording medium; and
a restriction unit that when the digital signal is recorded on the first and second recording medium, imposes different restrictions on the first and second recording medium.

2. The recording apparatus according to claim 1, wherein the restriction unit imposes local restrictions, which permit reproduction by the recording apparatus, on the digital signal to be recorded on the first recording medium, and imposes restrictions, which permit reproduction by any apparatus other than the recording apparatus, on the digital signal to be recorded on the second recording medium.

3. The recording apparatus according to claim 1, wherein when the first digital signal is recorded concurrently on the first and second recording medium, the restriction unit imposes local restrictions, which permit reproduction by the recording apparatus, on the digital signal to be recorded on the first recording medium, and imposes specification-conformable restrictions, which conform to a specification defined for the second recording medium, on the digital signal to be recorded on the second recording medium.

4. The recording apparatus according to claim 3, wherein when the first digital signal is recorded on one of the first and second recording medium, the restriction unit imposes specification-conformable restrictions, which conform to a specification defined for the first or second recording medium on which the first digital signal is recorded, on the first digital signal.

5. The recording apparatus according to claim 1, further comprising:
a local encryption key generation unit that generates a local encryption key to be used to impose local restrictions which permit reproduction by the recording apparatus;
a local decryption key generation unit that generates a local decryption key to be used to decrypt data which is recorded after having local restrictions imposed thereon;
a specification encryption key generation unit that generates a specification encryption key to be used to impose specification-conformable restrictions, which conform to each of security specifications defined for the first and second recording medium respectively, on the digital signal;
a specification decryption key generation unit that generates a specification decryption key to be used to decrypt data which is recorded after having specification-conformable restrictions imposed thereon; and
a key memory unit that holds the local encryption key, local decryption key, specification encryption key, and specification decryption key, wherein:
when the first digital signal is recorded concurrently on the first and second recording medium, the restriction unit uses the local encryption key stored in the key memory unit to impose restrictions on the digital signal to be recorded on the first recording medium, and uses the specification encryption key stored in the key memory unit to impose restrictions on the digital signal to be recorded on the second recording medium.

6. The recording apparatus according to claim 5, wherein when the first digital signal is recorded on one of the first and second recording medium, the restriction unit uses the specification encryption key stored in the key memory unit.

7. The recording apparatus according to claim 1, wherein the first and second recording medium are dismountable from the recording apparatus.

8. A recording/reproducing apparatus that records a digital signal on a recording medium and reproduces the digital signal from the recording medium, comprising:
a module which records the digital signal on a first recording medium and a second recording medium of the same type as the first recording medium;
a reproduction module which reproduces the digital signals from the first and second recording medium respectively; and
a control module which when the first digital signal is recorded concurrently on the first and second recording medium, imposes first restrictions, which restrict reproduction by any apparatus other than the recording/reproducing apparatus, on the first recording medium, and does or does not impose second restrictions, which are different from the first restrictions, on the second recording medium.

9. A recording method to be implemented by a recording apparatus that records a digital signal on a recording medium, comprising the steps of:
deciding whether the digital signal should be concurrently recorded on the first and second recording medium and whether the first and second recording medium are of the same type;
if a decision is made that the digital signal should be concurrently recorded on the first and second recording medium of the same type, imposing different restrictions on the first and second recording medium, and recording the digital signal on the first and second recording medium.
